(19) United States
(12) Patent Application Publication
(10) Pub. No.: US 2024/0185027 A1
(43) Pub. Date: Jun. 6, 2024

(54) MODEL TESTING USING TEST SAMPLE UNCERTAINTY

(71) Applicant: International Business Machines Corporation, Armonk, NY (US)

(72) Inventors: Deepak Vijaykeerthy, Bangalore (IN); Nishtha Madaan, Gurgaon (IN); Swagatam Haldar, Kolkata (IN); Aniya Aggarwal, NEW DELHI (IN); Diptikalyan Saha, Bangalore (IN)

(73) Assignee: International Business Machines Corporation, Armonk, NY (US)

(21) Appl. No.: 18/074,148

(22) Filed: Dec. 2, 2022

(51) Int. Cl. G06N 3/045; G06N 3/08

(52) U.S. Cl. CPC G06N 3/045; G06N 3/08

(57) ABSTRACT

Using encoded representations of target model training data and a label corresponding to each portion of the target model training data, a proxy model to determine an uncertainty score corresponding to an output of a trained target model is trained. Using the trained proxy model, a set of uncertainty scores is computed, each uncertainty score in the set of uncertainty scores corresponding to a portion of target model testing data in a set of target model testing data. A subset of the set of target model testing data is selected, the subset comprising a plurality of portions of target model testing data having an uncertainty score above a threshold uncertainty score. Using the subset of the set of target model testing data, the trained target model.

### BACKGROUND

The present invention relates generally to a method, system, and computer program product for testing a machine learning model. More particularly, the present invention relates to a method, system, and computer program product for model testing using test sample uncertainty.

Machine learning is the process of building a machine learning model, or simply a model, based on sample data, in order to make predictions or decisions without explicit programming. A machine learning model is trained before use, using training data. Training data typically includes data samples of the type the model is being trained to process, along with a label for each data sample indicating the correct decision for a data sample. For example, for a model being trained to classify images the training data might include a set of labelled images, with each label indicating the correct classification of the corresponding image. Model training generally proceeds until the model meets a training completion criterion, such as an error rate below a threshold.

Once trained, a model is tested before being deployed for operational use. Model testing requires testing data, which, like training data, typically includes data samples of the type the model is expected to correctly process, along with a label for each data sample indicating the correct decision for a data sample. Once deployed for operational use, some models are able to learn further, while other models are deployed in a static configuration that is not able to learn further.

### SUMMARY

The illustrative embodiments provide a method, system, and computer program product. An embodiment includes a method that trains, using encoded representations of portions of target model training data and a label corresponding to each portion of the target model training data, a proxy model to determine an uncertainty score corresponding to an output of a trained target model, the training resulting in a trained proxy model. An embodiment computes, using the trained proxy model, a set of uncertainty scores, each uncertainty score in the set of uncertainty scores corresponding to a portion of target model testing data in a set of target model testing data. An embodiment selects a subset of the set of target model testing data, the subset comprising a plurality of portions of target model testing data having an uncertainty score above a threshold uncertainty score. An embodiment tests, using the subset of the set of target model testing data, the trained target model.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for model testing using test sample uncertainty in accordance with an illustrative embodiment;

FIG. 3 depicts an example configuration of model testing using test sample uncertainty in accordance with an illustrative embodiment;

FIG. 4 depicts a flowchart of an example process for model testing using test sample uncertainty in accordance with an illustrative embodiment.

### DETAILED DESCRIPTION

The illustrative embodiments recognize that, to provide sufficient confidence that a model is performing as specified, the model requires testing. The testing data should include a variety of data samples, of data the model should perform well on as of data the model might not perform as well on. For example, if a model is trained to classify images of animals, some testing data might be high-quality images of common animals (e.g., images that include an entire dog or cat, easily distinguishable from the background), while other testing data might be images of subjects other than animals, images that include only a portion of an animal (e.g., a paw or tail), images that are difficult to distinguish from the background (e.g., a chameleon with coloration matching the ground underneath it), images of rare animals, and the like. However, the illustrative embodiments recognize that not all testing data is equally effective in determining how well the model functions. Some testing data might be redundant or might be very similar to the training data the model already performs well on, and testing with this data provides little additional information on the model's robustness. Model testing also requires time and resources, and it is desirable to minimize these. Thus, the illustrative embodiments recognize that there is a need to reduce the amount of model testing, while still providing sufficient confidence that the model is performing as specified.

In addition, the illustrative embodiments recognize that there are two sources of modeling uncertainty. Epistemic uncertainty refers to uncertainty of a model. Many trained models fit their training data well. However, because the training data may have been insufficient to train on all aspects of the phenomenon being modeled, a model may have knowledge gaps. Alcatoric uncertainty refers to noise in data, coming from human disagreement when labeling training data, measurement noise, missing data. Although epistemic uncertainty can be reduced with additional training data, aleatoric uncertainty is reducible only be improving the data itself. The illustrative embodiments recognize that there is a need to account for both epistemic and aleatoric uncertainty when performing model testing.

The illustrative embodiments recognize that the presently available tools or solutions do not address these needs or provide adequate solutions for these needs. The illustrative embodiments used to describe the invention generally address and solve the above-described problems and other problems related to model testing using test sample uncertainty.

An embodiment can be implemented as a software application. The application implementing an embodiment can be configured as a modification of an existing machine learning model configuration or deployment system, as a separate application that operates in conjunction with an existing machine learning model configuration or deployment system, a standalone application, or some combination thereof.

Particularly, some illustrative embodiments provide a method that uses encoded representations of target model training data and a label corresponding to each portion of the target model training data to train a proxy model to determine an uncertainty score corresponding to an output of a trained target model, uses the trained proxy model to compute a set of uncertainty scores corresponding to portions of target model testing data, selects a subset of the set of target model testing data, and tests the trained target model using the subset of the set of target model testing data.

An embodiment receives a trained model to be tested and, optionally, deployed. The model to be tested is referred to herein as a target model. An embodiment also receives a set of target model testing data, to be used in testing the target model. The testing data includes data samples of the type the target model is trained to correctly process, along with a label for each data sample indicating the correct decision for a data sample. For example, if the target model is trained to classify images of animals, testing data might be images (both of animals and of non-animals), along with a label for each image indicating the subject of the image. During testing, if the target model's output is closer than a threshold amount or percentage to the label, the target model's output is correct; otherwise, the target model's output is incorrect. An embodiment also receives a set of target model training data. Target model training data is data used to train the target model, and (like testing data) includes incudes data samples of the type the target model is trained to correctly process, along with a label for each data sample indicating the correct decision for a data sample. The target model training data that is received need not have been data actually used to train the target model, and not be all of the data actually used to train the target model.

An embodiment generates an encoded representation of a data sample in the set of target model training data. The encoded representation, also referred to as an embedding, encoding, or numerical representation, is typically a multidimensional set of numbers with real values between zero and one, that represents a point in a vector space. To generate an encoded representation, one embodiment uses a presently available technique suited to the type of data in a data sample. For example, Bidirectional Encoder Representations from Transformers (BERT), a transformer-based neural network model for natural language processing, is a presently available technique for computing encoded numerical representations of portions of text (e.g., words). As another example, a residual neural network (ResNet) is a presently available neural network model for computing encoded numerical representations of images. Both BERT and ResNet are typically trained before use. Another embodiment uses a portion of the trained target model to generate the encoded representation. For example, an input stage of a trained neural network model is often configured to generate a numerical representation of input to the model, for use in further processing by other portions of the model. Other encoding techniques are also possible and contemplated within the scope of the illustrative embodiments.

An embodiment uses encoded representations of target model training data and corresponding labels to train a second model to determine an arithmetic mean and a variance corresponding to an output of the trained target model. The second model is referred to herein as a proxy model, because it is a proxy for uncertainty in the target model's results. In statistics, an arithmetic mean, or simply the mean or average, is the sum of a collection of numbers divided by the count of numbers in the collection. Variance is the expectation of the squared deviation of a random variable from its mean, and thus variance is a measure of how far a set of numbers is spread out from their mean. One embodiment uses a Bayesian model, such as a Gaussian Process, to train the proxy model. A Bayesian model is a presently available statistical model that uses probability to represent uncertainty within a model's input and output. Gaussian Process is a presently available generic supervised learning method designed to solve regression and probabilistic classification problems. Other uncertainty scoring techniques are also possible and contemplated within the scope of the illustrative embodiments.

An embodiment uses the trained proxy model to compute a mean and variance for an encoded representation of a data sample in the target model testing data, and converts the mean and variance to a corresponding uncertainty score. One embodiment uses the trained proxy model to compute a mean and variance for an encoded representation of each data sample in the target model testing data, and converts the mean and variance to a corresponding uncertainty score. One embodiment computes an uncertainty score by subtracting a predetermined constant from the mean and dividing the result by the variance. Each uncertainty score corresponds to a portion of the target model testing data used as input to the trained proxy model.

An embodiment selects a subset of the set of target model testing data. In one embodiment, the selected subset includes all target model testing data having uncertainty scores above a threshold uncertainty score. In another embodiment, the selected subset includes target model testing data having the highest uncertainty scores—e.g., the ten portions of testing data with the highest uncertainty scores. In another embodiment, the selected subset includes target model testing data having the highest uncertainty scores, as long as those scores are also above a threshold uncertainty score. Other techniques for selecting a subset of the set of target model testing data are also possible and contemplated within the scope of the illustrative embodiments.

An embodiment tests the trained target model using the selected subset of target model testing data. To test the trained target model, an embodiment uses the selected subset of target model testing data as input to the target model, and checks whether the corresponding output of the target model matches, within a threshold amount or degree, expected output of the model. An embodiment reports a result of the testing to a human via a user interface, or to another software application, for use in determining whether the target model is ready to be deployed or needs further training or testing. Another embodiment does not test the trained target model itself, but instead supplies the selected subset of target model testing data to another application which uses the selected subset of target model testing data to test the target model and reports results to the embodiment.

If the testing results satisfy a testing success criterion, (e.g., for the animal image classification model 98% of images tested were classified into the correct category), an embodiment automatically deploys the target model for use on production (i.e., not training or testing) data. Another embodiment does not perform the deployment, but instead reports testing success to another application which performs the actual deployment. If the testing results do not satisfy a testing success criterion, an embodiment selects additional testing data in a manner described herein and retests the target model with the selected additional testing data. If the testing results do not satisfy a testing success criterion, another embodiment rejects the target model with a report of the test results and an indication that additional model training is required before deployment. If the testing results do not satisfy a testing success criterion, another embodiment uses a combination approach, selecting additional testing data and retesting the target model if test results were within a predetermined range (indicating that testing so far is inconclusive), and rejecting the target model outright if test results were outside the predetermined range (indicating that the target model has definitely failed testing).

The manner of model testing using test sample uncertainty described herein is unavailable in the presently available methods in the technological field of endeavor pertaining to machine learning models. A method of an embodiment described herein, when implemented to execute on a device or data processing system, comprises substantial advancement of the functionality of that device or data processing system in using encoded representations of target model training data and a label corresponding to each portion of the target model training data to train a proxy model to determine an uncertainty score corresponding to an output of a trained target model, using the trained proxy model to compute a set of uncertainty scores corresponding to portions of target model testing data, selecting a subset of the set of target model testing data, and testing the trained target model using the subset of the set of target model testing data.

The illustrative embodiments are described with respect to certain types of training data, testing data, neural network models, machine learning models, thresholds, scores, rankings, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

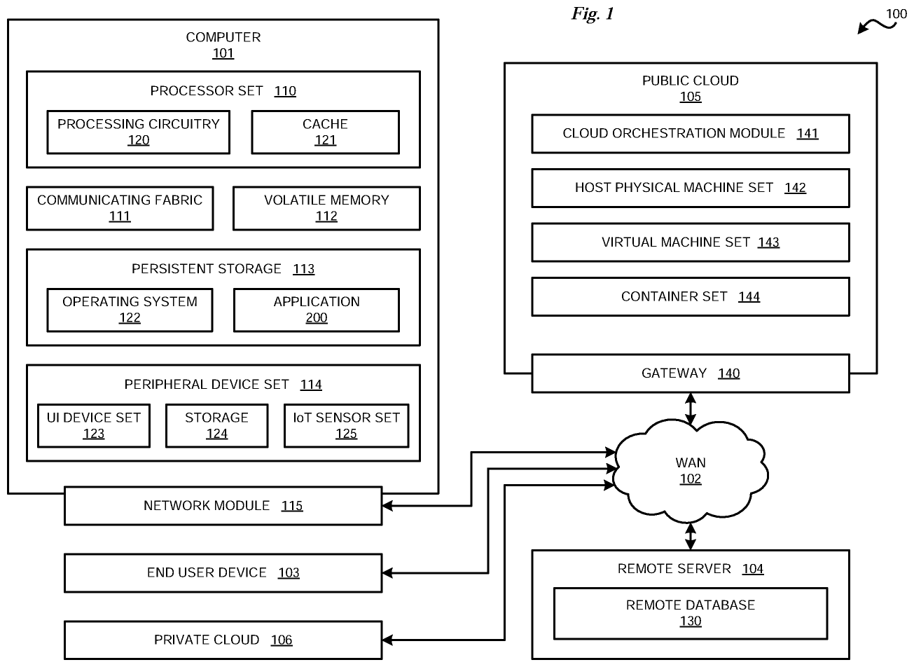

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a model testing using test sample uncertainty embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IOT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

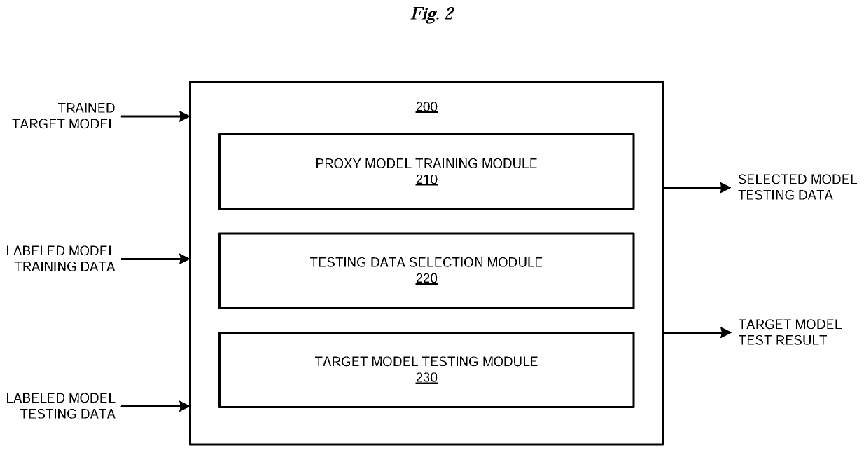

With reference to FIG. 2, this figure depicts a block diagram of an example configuration for model testing using test sample uncertainty in accordance with an illustrative embodiment. Application 200 is the same as application 200 in FIG. 1.

Application 200 receives a trained target model to be tested and, optionally, deployed. Application 200 also receives a set of target model testing data, to be used in testing the target model. The testing data includes data samples of the type the target model is trained to correctly process, along with a label for each data sample indicating the correct decision for a data sample. Application 200 also receives a set of target model training data.

Proxy module training module 210 generates an encoded representation of a data sample in the set of target model training data. The encoded representation, also referred to as an embedding, encoding, or numerical representation, is typically a multidimensional set of numbers with real values between zero and one, that represents a point in a vector space. To generate an encoded representation, one implementation of module 210 uses a presently available technique suited to the type of data in a data sample. For example, BERT is a presently available technique for computing encoded numerical representations of portions of text, and ResNet is a presently available neural network model for computing encoded numerical representations of images. Both BERT and ResNet are typically trained before use. Another implementation of module 210 uses a portion of the trained target model to generate the encoded representation. For example, an input stage of a trained neural network model is often configured to generate a numerical representation of input to the model, for use in further processing by other portions of the model.

Module 210 uses encoded representations of target model training data and corresponding labels to train a proxy model to determine an arithmetic mean and a variance corresponding to an output of the trained target model. One implementation of module 210 uses a Bayesian model, such as a Gaussian Process, to train the proxy model.

Testing data selection model 220 uses the trained proxy model to compute a mean and variance for an encoded representation of a data sample in the target model testing data, and converts the mean and variance to a corresponding uncertainty score. One implementation of module 220 uses the trained proxy model to compute a mean and variance for an encoded representation of each data sample in the target model testing data, and converts the mean and variance to a corresponding uncertainty score. One implementation of module 220 computes an uncertainty score by subtracting a predetermined constant from the mean and dividing the result by the variance. Each uncertainty score corresponds to a portion of the target model testing data used as input to the trained proxy model.

Module 220 selects a subset of the set of target model testing data. In one implementation of module 220, the selected subset includes all target model testing data having uncertainty scores above a threshold uncertainty score. In another implementation of module 220, the selected subset includes target model testing data having the highest uncertainty scores—e.g., the ten portions of testing data with the highest uncertainty scores. In another implementation of module 220, the selected subset includes target model testing data having the highest uncertainty scores, as long as those scores are also above a threshold uncertainty score.

Target model testing module 230 tests the trained target model using the selected subset of the set of target model testing data. To test the trained target model, module 230 uses the selected subset of target model testing data as input to the target model, and checks whether the corresponding output of the target model matches, within a threshold amount or degree, expected output of the model. Module 230 reports a result of the testing to a human via a user interface, or to another software application, for use in determining whether the target model is ready to be deployed or needs further training or testing. Another implementation of module 230 does not test the trained target model itself, but instead supplies the selected subset of target model testing data to another application which uses the selected subset of target model testing data to test the target model and reports results to module 230.

If the testing results satisfy a testing success criterion, (e.g., for the animal image classification model 98% of images tested were classified into the correct category), application 200 automatically deploys the target model for use on production (i.e., not training or testing) data. Another implementation of application 200 does not perform the deployment, but instead reports testing success to another application which performs the actual deployment. If the testing results do not satisfy a testing success criterion, module 220 selects additional testing data in a manner described herein and module 230 retests the target model with the selected additional testing data. If the testing results do not satisfy a testing success criterion, another implementation of application 200 rejects the target model with a report of the test results and an indication that additional model training is required before deployment. If the testing results do not satisfy a testing success criterion, another implementation of application 200 uses a combination approach, selecting additional testing data and retesting the target model if test results were within a predetermined range (indicating that testing so far is inconclusive), and rejecting the target model outright if test results were outside the predetermined range (indicating that the target model has definitely failed testing).

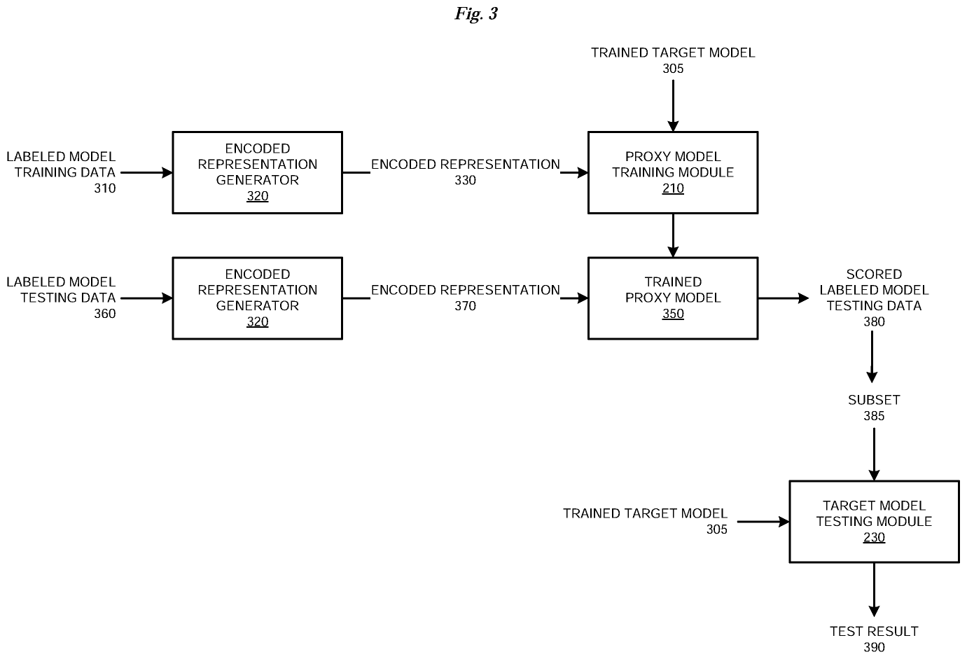

With reference to FIG. 3, this figure depicts an example configuration of model testing using test sample uncertainty in accordance with an illustrative embodiment. The example can be executed using application 200 in FIG. 2. Proxy module training module 210 and target model testing module 230 are the same as proxy module training module 210 and target model testing module 230 in FIG. 2.

As depicted, encoded representation generator 320 generates encoded representation 330 from labeled model training data 310, a data sample in the set of target model training data. Encoded representation generator 320 also generates encoded representation 370 from labeled model testing data 360, a data sample in the set of target model testing data. To generate an encoded representation, encoded representation generator 320 uses a presently available technique suited to the type of data in a data sample, such as BERT, ResNet, or a portion of the trained target model.

Proxy module training module 210 uses encoded representations 330 of target model training data and corresponding labels to train a proxy model to determine an arithmetic mean and a variance corresponding to an output of trained target model 305. The result is trained proxy model 350.

Testing data selection model 220 uses trained proxy model 350 to compute a mean and variance for encoded representation 370, and converts the mean and variance to a corresponding uncertainty score. The result is scored labeled model testing data 380. From scored labeled model testing data 380, module 220 selects subset 385.

Target model testing module 230 tests trained target model 305 using subset 385. To test trained target model 305, module 230 uses subset 385 as input to target model 305, and checks whether the corresponding output of target model 305 matches, within a threshold amount or degree, expected output of model 305. The result is depicted as test result 390.

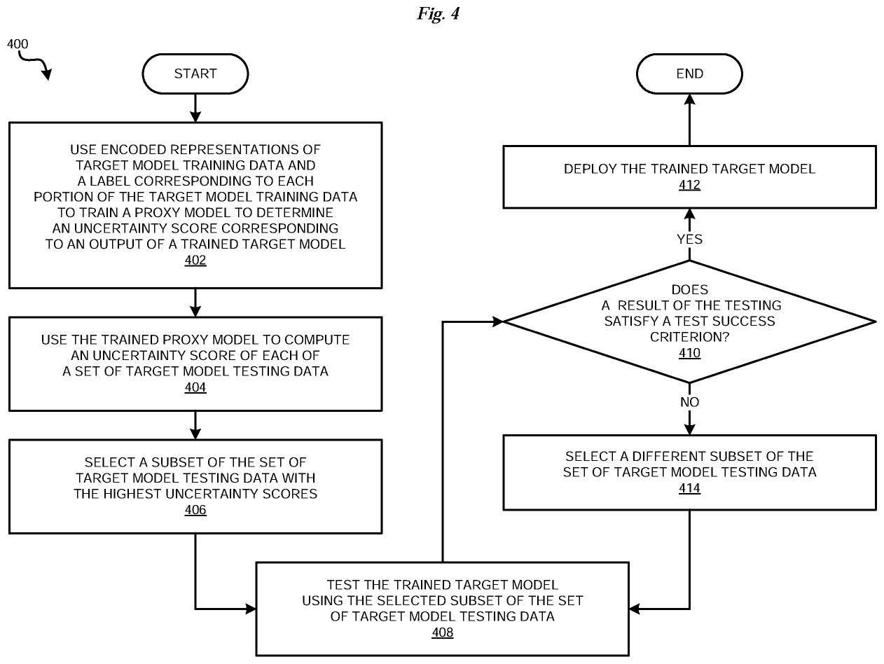

With reference to FIG. 4, this figure depicts a flowchart of an example process for model testing using test sample uncertainty in accordance with an illustrative embodiment. Process 400 can be implemented in application 200 in FIG. 2.

In block 402, the application uses encoded representations of target model training data and a label corresponding each portion of the target model training data to train a proxy model to determine an uncertainty score corresponding to an output of a trained target model. In block 404, the application uses the trained proxy model to compute an uncertainty score of each of a set of target model testing data. In block 406, the application selects a subset of the set of target model testing data with the highest uncertainty scores. In block 408, the application tests the trained target model using the selected subset of the set of target model testing data. In block 410, the application determines whether a result of the testing satisfies a test success criterion. If yes (“YES” path of block 410), in block 412, the application deploys the trained target model. If no (“NO” path of block 410), in block 414, the application selects a different subset of the set of target model testing data. Then the application ends.

Thus, a computer implemented method, system or apparatus, and computer program product are provided in the illustrative embodiments for model testing using test sample uncertainty and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
training, using encoded representations of portions of target model training data and a label corresponding to each portion of the target model training data, a proxy model to determine an uncertainty score corresponding to an output of a trained target model, the training resulting in a trained proxy model;
computing, using the trained proxy model, a set of uncertainty scores, each uncertainty score in the set of uncertainty scores corresponding to a portion of target model testing data in a set of target model testing data;
selecting a subset of the set of target model testing data, the subset comprising a plurality of portions of target model testing data each having an uncertainty score above a threshold uncertainty score; and
testing, using the subset of the set of target model testing data, the trained target model.

2. The computer-implemented method of claim 1, further comprising:
generating, using a third trained neural network model, an encoded representation of a portion of the target model training data.

3. The computer-implemented method of claim 1, wherein the trained proxy model outputs a mean and a variance, and wherein the uncertainty score is computed by subtracting a predetermined constant from the mean and dividing a result of the subtracting by the variance.

4. The computer-implemented method of claim 1, further comprising:
deploying, responsive to a first result of the testing satisfying a test success criterion, the trained target model.

5. The computer-implemented method of claim 1, further comprising:
selecting, responsive to a second result of the testing failing to satisfy a test success criterion, a second subset of the set of target model testing data, the second subset comprising a plurality of portions of target model testing data not included in the subset of the set of target model testing data; and
retesting, using the second subset of the set of target model testing data, the trained target model.

6. The computer-implemented method of claim 1, further comprising:
rejecting, responsive to the testing failing to satisfy a test success criterion, the trained target model for deployment.

7. A computer program product comprising one or more computer readable storage medium, and program instructions collectively stored on the one or more computer readable storage medium, the program instructions executable by a processor to cause the processor to perform operations comprising:
training, using encoded representations of portions of target model training data and a label corresponding to each portion of the target model training data, a proxy model to determine an uncertainty score corresponding to an output of a trained target model, the training resulting in a trained proxy model;
computing, using the trained proxy model, a set of uncertainty scores, each uncertainty score in the set of uncertainty scores corresponding to a portion of target model testing data in a set of target model testing data;
selecting a subset of the set of target model testing data, the subset comprising a plurality of portions of target model testing data each having an uncertainty score above a threshold uncertainty score; and
testing, using the subset of the set of target model testing data, the trained target model.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
generating, using a third trained neural network model, an encoded representation of a portion of the target model training data.

11. The computer program product of claim 7, wherein the trained proxy model outputs a mean and a variance, and wherein the uncertainty score is computed by subtracting a predetermined constant from the mean and dividing a result of the subtracting by the variance.

12. The computer program product of claim 7, further comprising:
deploying, responsive to a first result of the testing satisfying a test success criterion, the trained target model.

13. The computer program product of claim 7, further comprising:
selecting, responsive to a second result of the testing failing to satisfy a test success criterion, a second subset of the set of target model testing data, the second subset comprising a plurality of portions of target model testing data not included in the subset of the set of target model testing data; and
retesting, using the second subset of the set of target model testing data, the trained target model.

14. The computer program product of claim 7, further comprising:
rejecting, responsive to the testing failing to satisfy a test success criterion, the trained target model for deployment.

15. A computer system comprising a processor and one or more computer readable storage media, and program instructions collectively stored on the one or more computer readable storage media, the program instructions executable by the processor to cause the processor to perform operations comprising:
training, using encoded representations of portions of target model training data and a label corresponding to each portion of the target model training data, a proxy model to determine an uncertainty score corresponding to an output of a trained target model, the training resulting in a trained proxy model;
computing, using the trained proxy model, a set of uncertainty scores, each uncertainty score in the set of uncertainty scores corresponding to a portion of target model testing data in a set of target model testing data;
selecting a subset of the set of target model testing data, the subset comprising a plurality of portions of target model testing data each having an uncertainty score above a threshold uncertainty score; and
testing, using the subset of the set of target model testing data, the trained target model.

16. The computer program product of claim 15, further comprising:
generating, using a third trained neural network model, an encoded representation of a portion of the target model training data.

17. The computer program product of claim 15, wherein the trained proxy model outputs a mean and a variance, and wherein the uncertainty score is computed by subtracting a predetermined constant from the mean and dividing a result of the subtracting by the variance.

18. The computer program product of claim 15, further comprising:
deploying, responsive to a first result of the testing satisfying a test success criterion, the trained target model.

19. The computer program product of claim 15, further comprising:
selecting, responsive to a second result of the testing failing to satisfy a test success criterion, a second subset of the set of target model testing data, the second subset comprising a plurality of portions of target model testing data not included in the subset of the set of target model testing data; and
retesting, using the second subset of the set of target model testing data, the trained target model.

20. The computer program product of claim 15, further comprising:
rejecting, responsive to the testing failing to satisfy a test success criterion, the trained target model for deployment.
